(19) United States
(12) Patent Application Publication
(10) Pub. No.: US 2006/0176894 A1
(43) Pub. Date: Aug. 10, 2006

(54) Routing method and apparatus for reducing loss of IP packets

(76) Inventors: Jong-Sang Oh, Suwon-si (KR); Byung-Chang Kang, Yongin-si (KR); Yong-Seok Park, Seongnam-si (KR)

Correspondence Address: Robert E. Bushnell;Suite 300, 1522 K Street, N.W., Washington, DC, 20005, US

(21) Appl. No.: 11/330,252

(22) Filed: Jan. 12, 2006

(30) Foreign Application Priority Data
Feb. 4, 2005 (KR) 2005-10831

(51) Int. Cl. H04L 12/56; H04L 12/28

(52) U.S. Cl. 370/413

(57) ABSTRACT

A network routing method for preventing packet drop or loss comprises the steps of presetting best and second routes for the same destination, determining a route for an inputted packet with reference to the preset best and second routes, selectively queuing the inputted packet to respective output queues of the preset best and second routes in accordance with whether there is congestion in the output queues of the preset best and second routes, and sequentially queuing the packets stored in the output queues of the preset best and second routes, and transporting same to output ports of corresponding routes, in accordance with an order of input thereof. A network routing apparatus comprises a forwarding table, a forwarding section, a queue management section, and a transport section for use in performing functions corresponding to the above steps.

### CLAIM OF PRIORITY

This application makes reference to, incorporates the same herein, and claims all benefits accruing under 35 U.S.C. §119 from an application for ROUTING METHOD AND APPARATUS FOR REDUCING LOSS OF IP PACKETS earlier filed in the Korean Intellectual Property Office on Feb. 4, 2005 and there duly assigned Ser. No. 2005-10831.

### BACKGROUND OF THE INVENTION

1. Technical Field

The present invention relates to a network routing method and apparatus, and more particularly, to a network routing method and apparatus which reduces loss of Internet protocol (IP) packets that occurs later through the storing in overload of IP packets in a queue for temporarily storing the same when IP packets are transmitted via a preset route path.

2. Related Art

With the present rapid increase in Internet users, diversified services provided, and utility extension of voice over Internet protocol (VoIP), and so forth, traffic on the Internet has been increasing exponentially. Therefore, in order to transmit IP packets to a corresponding destination on the Internet, especially in the case of tens of Giga or Tera class high speed routers, a technical issue has been arising relative to the retrieval, within the shortest seek time, of a destination path of the corresponding packet without time delay, and the forwarding of the same. To this end, the functions of maintenance of a shortest path (routing or forwarding) table, effective management of a path table, seek time reduction, and so forth are essentially required in order to seek the destination path of an IP packet transported via a physical input interface of each router.

One of the important characteristics required by the next generation Internet is high reliability. Due to an increase in high value added mission-critical traffic, real-time traffic, high-priority traffic and so forth, a need for providing such traffic stably at any time is on the rise. Also, with the development of a network into one with high speed and mass capability, a greater quantity of data is transmitted so that, upon the occurrence of a failure, data loss and damage caused by service interruption may become serious. It is, therefore, basically required that the next generation Internet be provided with an effective mechanism for detecting a failure rapidly upon the occurrence of the failure, and for recovering services within a short time so as to provide the services continuously.

Generally, there have been many studies to discover a method for effectively recovering services when failure occurs in a network link.

In the meantime, in view of quality of signal (QoS) considerations, many methods for congestion avoidance in order to deal with congestion of traffic packets have been proposed. For such congestion avoidance, such algorithms as tail drop (TD), random early drop (RED) and waited random early drop (WRED) are presently used. However, since these methods focus their attention simply on effective dropping of traffic packets, they may be the technologies that basically allow a drop of traffic packets.

Accordingly, there is a need in the prior art for a way of reducing damage and data loss by service interruption possibly generated due to a drop of traffic packets, and for a way of providing more stable services.

### SUMMARY OF THE INVENTION

It is, therefore, an object of the present invention to provide a method and apparatus for network routing, which method and apparatus are capable of reducing a drop in traffic packets generated due to congestion of traffic packets transported via a preset route.

It is another object to provide a method and apparatus for network routing, which method and apparatus reduce a drop in the traffic packets transported via the best route when the best and second routes are preset for the same destination.

It is yet another object to provide a method and method for network routing in which a drop of traffic packets due to traffic congestion is reduced using a best route and a second route.

To achieve the above and other objects, there is provided a network routing method for preventing a packet drop, the method comprising the steps of: (a) presetting best and second routes for the same destination; (b) determining best and second routes for an inputted packet with reference to information on the preset best and second routes; (c) selectively queuing the inputted packet to a best queue and a second queue regardless of whether or not there is packet congestion in the best queue and the second queue disposed in correspondence to the best and second routes; and (d) sequentially queuing the packets outputted to and stored in the best and second queues, and transporting them to output ports of the corresponding routes in accordance with an order of input thereof.

Preferably, step (c) comprises the sub-steps of: selecting the best queue as the queue for queuing packets according to the determined best route of a packet; determining whether the best queue is congested with packets stored therein; if it is determined that the best queue is in a congested state, designating the second queue as the queue for queuing inputted packets; determining whether the second queue is congested with packets stored therein; and, if it is determined that the second queue is not in a congested state, queuing the inputted packets to the second queue.

The network routing method of this embodiment further comprises the step of dropping the inputted packets if the second queue is determined to be in a congested state.

In addition, the network routing method of this embodiment further comprises the steps of: comparing the number of packets accumulated in the second queue with a preset maximum threshold value during queuing of the inputted packets to the second queue; and, if the number of packets accumulated in the second queue is determined to be more than the preset maximum threshold value, designating the second queue to be in the congested state.

Preferably, the network routing method of this embodiment further comprises the steps of: queuing the inputted packets to the best queue if the best queue is not in a congested state; comparing the number of packets accumulated in the best queue with a preset maximum threshold value during queuing of the inputted packets to the best queue; and, if the number of packets accumulated in the best queue is determined to be more than the preset maximum threshold value, designating the best queue to be in the congested state.

Preferably, step (d) further comprises the sub-steps of: determining the queue that stores the packets to be transported, according to an order of input, from the best and second queues; extracting the packets stored in the determined queue so as to queue and transport the same to the corresponding output port; comparing the number of packets accumulated in the determined queue with a preset threshold value; and, if the number of packets accumulated in the determined queue is determined to be less than the preset threshold value, designating the determined queue to not be in the congested state.

According to another aspect of the present invention, there is provided an apparatus for network routing, the apparatus comprising: a forwarding table in which information on the preset best and second routes for the same destination is stored; a forwarding section for determining best and second routes for inputted packets with reference to the forwarding table; a queue management section for selectively queuing inputted packets to a best queue and a second queue dependent upon whether or not there is a packet congestion in the best queue and the second queue disposed in correspondence to the best and second routes; and a transport section for sequentially queuing the packets outputted to and stored in the best and second queues, and for transporting them to output ports of the corresponding routes in accordance with an order of input thereof.

Preferably, the network routing apparatus of this embodiment further comprises a queue information storing section which stores queue status information, including information on whether or not the best and second queues are congested with packets, and information on the number of packets presently stored in the corresponding queue. Accordingly, the queue management section selectively queues the inputted packets to the best and second queues based on queue status information.

The queue management section designates the second queue as the queue for queuing the inputted packets if the best queue through the best route determined by the forwarding section is in a congested state, and queues the inputted packets to the second queue if the second queue is not in a congested state.

The queue management section drops the inputted packets if the second queue is in a congested state.

The queue management section designates the second queue to be in a congested state if the number of packets accumulated in the second queue is more than a preset maximum threshold value during queuing of the inputted packets to the second queue.

The queue management section queues the inputted packets to the best queue if the best queue is not in a congested state, and designates the best queue to be in a congested state if the number of packets accumulated in the best queue is more than the preset maximum threshold value during queuing of the inputted packets to the best queue.

The transport section determines the queue that stores packets to be transported according to an order of input from the best and second queues, draws out or extracts the packets stored in the determined queue, and queues and transports the same to the corresponding output ports.

Preferably, the transport section designates the determined queue to not be in a congested state if the number of packets accumulated in the determined queue is less than a preset threshold value.

According to the present invention, with the setting of the best and second routes, if the best route is congested with packets in linking thereto, thereby generating congestion, the packets that are inputted thereafter and possibly dropped are queued and transported via the second route, thereby reducing packet drop generated due to a congestion of packets inputted. In addition, based on whether or not there is congestion due to packet congestion in the best queue, the inputted packets are selectively queued to the best queue or the second queue, thereby queuing and transporting the same to the corresponding destination via the best route or the second route, and thereby reducing packet drop due to congestion of packets inputted, providing more stable services, and securing high reliability for network packet transport service.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a diagram of an example of a network construction having at least one path for a specific destination;

FIG. 2 is a diagram of an example of rerouting upon failure generation in a network having a multi-destination route;

FIG. 3 is a diagram of an example of a router for setting best and second routes;

FIG. 4 is a block diagram of an example of packet loss due to packet congestion;

FIG. 5 is a block diagram of a preferred embodiment of a network routing apparatus for preventing packet loss or drop according to the present invention;

FIG. 6 is a flowchart of a preferred embodiment of a network routing method using a network routing apparatus according to the present invention;

FIG. 7 is a flowchart of step S200 of FIG. 6 in more detail; and

FIG. 8 is a flowchart of step S400 of FIG. 6 in more detail.

### DETAILED DESCRIPTION OF THE INVENTION

Hereinafter, the preferred embodiment of the present invention will be described in detail with reference to the accompanying drawings in which like reference symbols indicate the same or similar components. In addition, a detailed description on functions and configurations known in the art that may unnecessarily render the gist of the present invention ambiguous will be omitted.

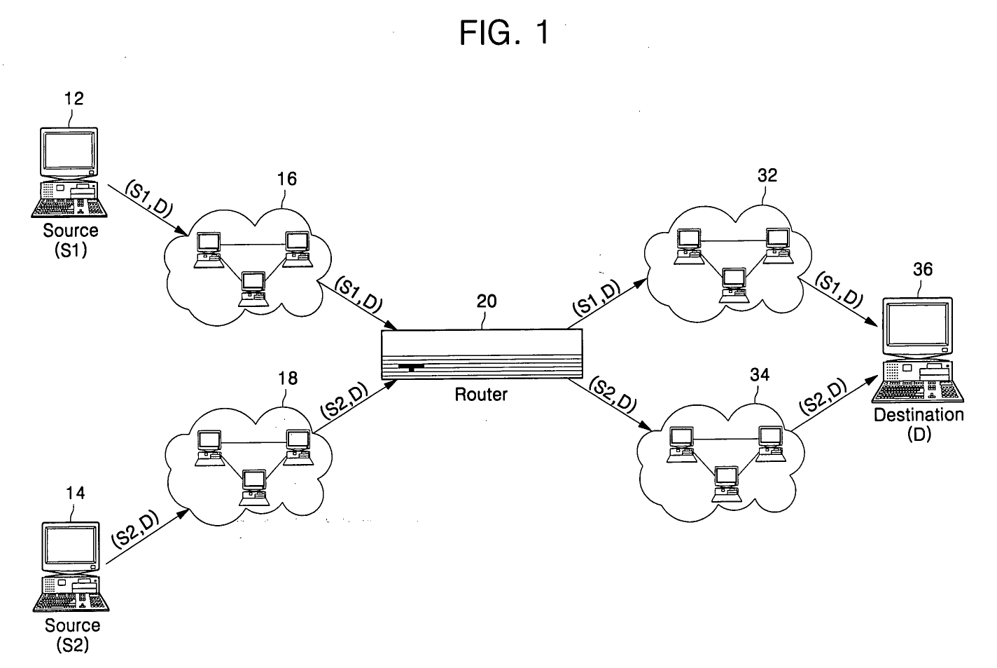

FIG. 1 is a diagram of an example of a network construction having at least one path for a specific destination.

In FIG. 1, a router 20 selects a best route with least cost for each of source 12 and source 14. The route of source 12 may be preset as a first network 16-the router 20-a third network 32-a destination 36, or otherwise as the first network 16-the router 20-a fourth network 34-the destination 36. Also, the route of source 14 may be preset as a second network 18-the router 20-the third network 32-the destination 36, or otherwise as the second network 18-the router 20-the fourth network 34-the destination 36.

In FIG. 1, it is preset that the best route for source 12 is the first network 16-the router 20-the third network 32-the destination 36, and the best route for source 14 is the second network 18-the router 20-the third network 32-the destination 36.

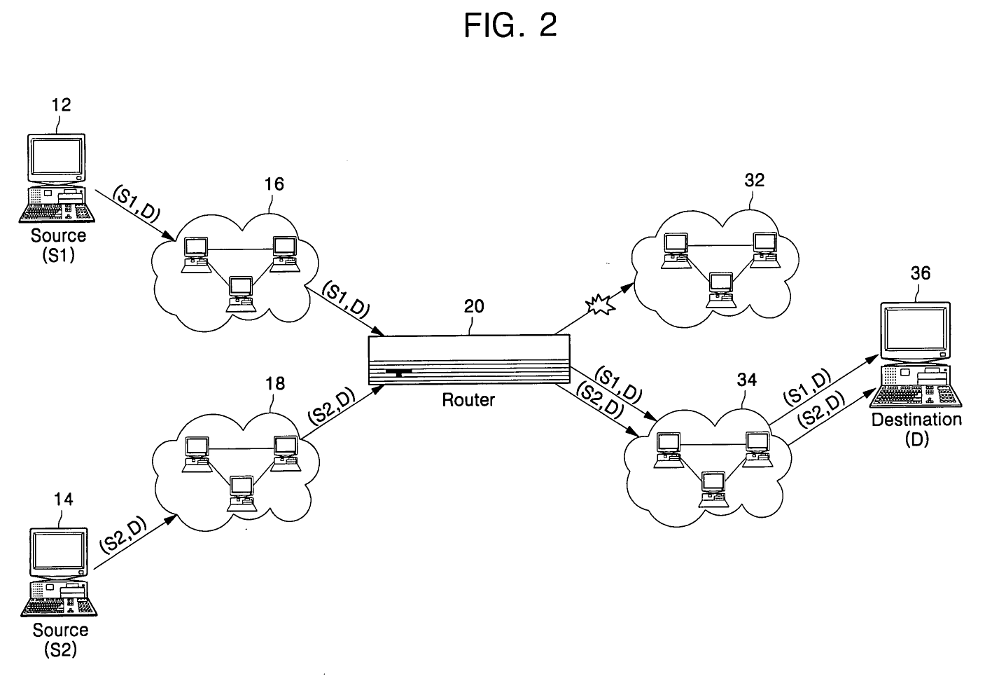

FIG. 2 is a diagram of an example of rerouting upon failure generation in a network having a multi-destination route;

As shown in FIG. 2, if failure occurs between the router 20 and the third network 32 in the preset best route, the router 20 conducts rerouting at an IP layer based on an interior gateway protocol (IGP), thus recovering from the network failure. Herein, examples of IGP are open short path first (OSPF) and intermediate system to intermediate system (ISIS).

The router 20 transports IP packets, inputted through an optimum path, to the preset route using present topology information. At this time, if a failure occurs in network link, the router 20 floods a link state advertisement into the network, drives a shortest path first (SPF) algorithm to re-calculate an optimum path to preset a best route, and transports IP packets to the preset route.

Such a method may use network resources effectively and be smoothly adaptable to a change of topology, but it has a problem in that recovery speed is seriously slow (a few seconds to a few minutes) due to various timers under consideration of instability of routing.

To resolve this problem, methods have been proposed that preset timers to a minimum, but the methods have not been used in practice due to dangers of an increase in control traffic and instability of routing.

As such, if a failure occurs in a network route preset as a best route, in order to reduce the loss of IP packets during recovery from the failure, a method has been proposed that presets a second route as the second best route together with the best route.

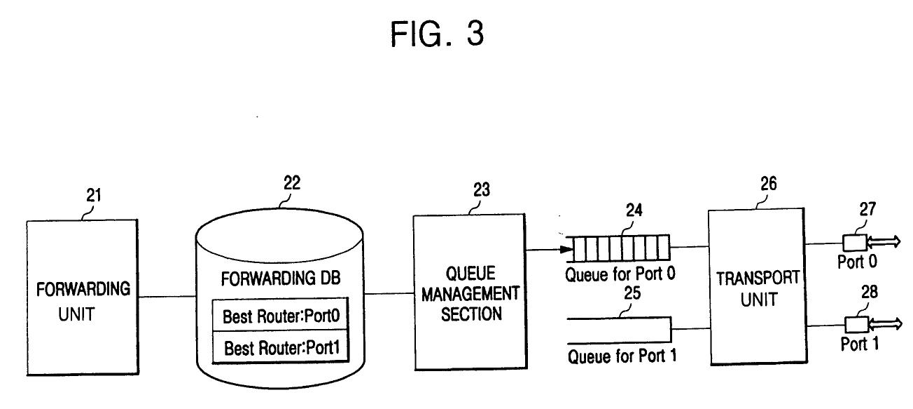

FIG. 3 is a diagram of an example of a router for setting best and second routes. With reference to the router shown in FIG. 3, in explaining the operation thereof, it will be assumed that it is disposed at the same position as that of the router 20 arranged in the network illustrated in FIGS. 1 and 2.

The router in the drawing presets a best route with the least cost for individual sources 12 and 14, and a second route with cost secondarily to that of the best route. At this point, the router forms the preset best and second route information into a forwarding table, and stores the same in forwarding database (DB) 22.

In the drawing, the route of source 12 is preset as the first network 16-the router 20-the third network 32-the destination 36, or otherwise as the first network 16-the router 20-the fourth network 34-the destination 36. Also, the route of source 14 is preset as the second network 18-the router 20-the third network 32-the destination 36, or otherwise as the second network 18-the router 20-the fourth network 34-the destination 36.

In FIG. 3, it is preset such that the best route for source 12 is the first network 16-the router 20-the third network 32-the destination 36, and the second route for the same is the first network 16-the router 20-the fourth network 34-the destination 36. Also, it is preset such that the best route for source 14 is the second network 18-the router 20-the third network 32-the destination 36, and the second route for the same is the second network 18-the router 20-the fourth network 34-the destination 36.

A forwarding unit 21 detects a destination address from an input IP packet, and obtains the best and second routes for the detected destination address with reference to forwarding DB 22. Herein, the forwarding unit 21 transports route information to a queue management section 23 while including the same in the IP packet.

The queue management section 23 queues the IP packet to a best queue 24 in accordance with route information included in the input IP packet. A transmission unit 26 gets an IP packet from the best queue 24, and transmits the same by routing through an output interface port (port 0) 27.

Herein, if a failure occurs in the best route, the queue management section 23 queues the input IP packet to a second queue 25. Thus, the transmission unit 26 gets the IP packet from the second queue 25, and transmits the same by routing through an output interface port (port 1) 28.

However, even if a failure does not occur in a network, due to input congestion of packet for a queue in specific route, packets inputted later into the corresponding queue become dropped.

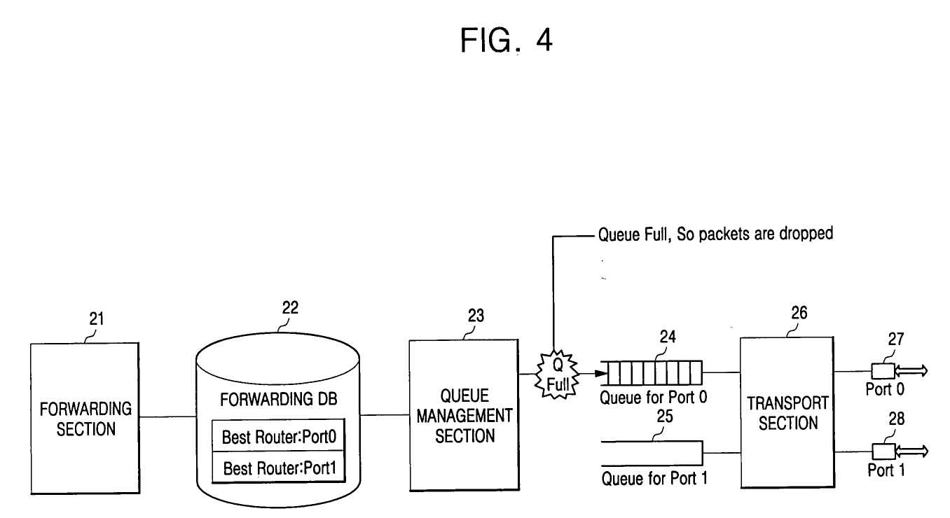

FIG. 4 is a block diagram of an example of packet loss due to packet congestion.

As shown in FIG. 4, if in a state free from network failure, the congestion (queue=full) possibly occurs due to input congestion of a packet to the best queue 24, and a problem arises in that, since packets are stored in the best queue 24 with a congested state, packets inputted thereafter are dropped.

If a link corresponding to an optimum route established by an SPF algorithm and so forth is congested with the user's traffic, and the quantity of traffic packets exceeds a transfer rate of the link corresponding to the optimum route, the user's traffic packets are to be dropped to the extent of the excessive quantity (in case of the best queue 24 in FIG. 4). Such packet loss of user traffic causes data retransmission between network terminations, which is a serious problem of quality degradation of services.

That is, if the link corresponding to the optimum route (the best queue 24 in FIG. 4) is congested with traffic, when the queue of packets, which is a storable space which all of the ports connected to the corresponding link have, is fully occupied (Queue=Full), the queue management section 23 drops corresponding traffic packets inputted thereafter.

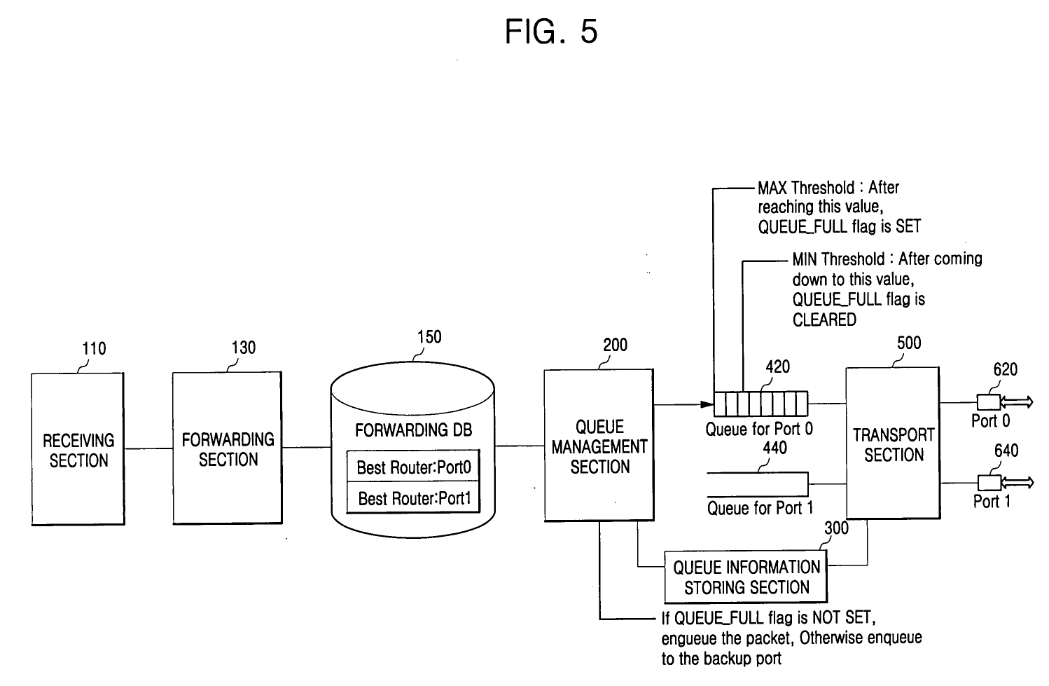

FIG. 5 is a block diagram of a preferred embodiment of a network routing apparatus for preventing a packet loss or drop according to the present invention. In FIG. 5, as for the routing apparatus, a router is employed. Therefore, a router is exemplarily explained as follows.

As shown in FIG. 5, the router includes a receiving section 110, a forwarding section 130, a forwarding database (DB) 150, a queue management section 200, queues 420 and 440, a queue information storing section 300, and a transport section 500.

The receiving section 110 detects packets introduced from an exterior source, and receives the detected packets so as to queue the same in the forwarding section 130.

The forwarding section 130 detects an output port of the packets received in the receiving section 110 with reference to a forwarding table stored in the forwarding database 150 through a destination address for the packets. Herein, the forwarding section 130 outputs detected output port information to the queue management section 200 while including the same in the packets.

Meanwhile, in the forwarding database 150, information as to the best and second routes preset for the same destination address is stored as a table corresponding to an input port connected to the receiving section 110. That is, in the forwarding database 150, the output ports corresponding to the best and second routes are set for each input port of the router, and are stored as a forwarding table.

Thus, the forwarding section 130 detects the best and second output ports corresponding to the input port of the received packet with reference to the forwarding table stored in the forwarding database 150.

The queue management section 200 detects output port information for queuing the packet from the queued packet, and queues (outputs and stores) the packet in the corresponding queue 420 or 440 set corresponding to the detected output port.

The transport section 500 determines whether there are packets existing (stored) in the queue 420 or 440 set to the output ports 620 and 640, respectively. Herein, if the packet queued from the queue management section 200 and stored exists in the corresponding queue 420 or 440, the transport section 500 draws out or extracts the packet from the corresponding queue, queues it, and transports it to the corresponding output port.

Meanwhile, the queue management section 200 stores, in real time, in the queue information storing section 300, a preset maximum/minimum threshold value for the best queue 420 corresponding to the best route and the second queue 440 corresponding to the second route, regardless of whether there is a congestion due to input packet congestion, and status information of the corresponding queue, such as Queue Full flag information.

Thus, the queue management section 200 queues the packets selectively to the best queue 420 or the second queue 440, according to a status of the corresponding queues 420 and 440 stored in the queue information storing section 300. Preferably, if it is determined from status information of the queue that the number of packets stored in the best queue 420 is more than the preset maximum threshold value, the queue management section 200 queues the packets inputted thereafter to the second queue 440. Moreover, the queue management section 200 sets the Queue_Full flag of the best queue 420 to ‘1’.

In addition, if the number of packets stored in the best queue 420 is less than the preset minimum threshold value, the queue management section 200 queues the packets inputted thereafter from the second queue 440 to the best queue 420. At this point, the queue management section 200 sets the Queue_Full flag of the best queue 420 to ‘0’.

The transport section 500 extracts the packets in the order inputted to the corresponding queues 420 and 440, queues the same, and transports the same to the output port 620 or 640 correspondingly connected to the corresponding queue. That is, when the transport section 420 extracts the packet from the best queue 420, it queues the extracted packet and transports it via the best output port 620 along the best route. In addition, when the transport section 420 extracts the packet from the second queue 440, it queues the extracted packet and transports it via the second output port 620 along the second route.

Thus, if the best queue 420 is fully occupied with the packets to be transported, the packets inputted thereafter are queued and transported to the second queue 440, and if the number of packets stored in the best queue 420 is less than the preset minimum threshold value, the packets inputted thereafter are queued and transported to the best queue 420. Accordingly, the packets inputted are selectively queued and transported, thereby reducing packet loss or drop generated due to a congestion of packets inputted.

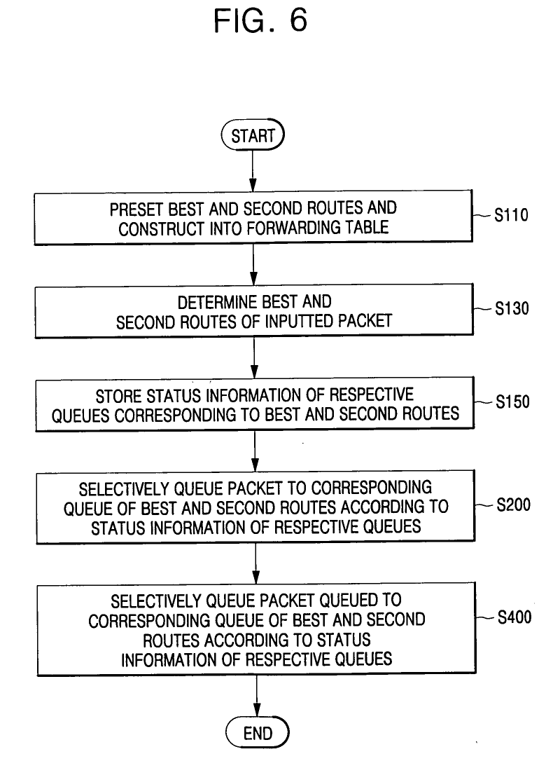

FIG. 6 is a flowchart of a preferred embodiment of a network routing method using a network routing apparatus according to the present invention.

First, the routing apparatus (router) sets the best and second routes for the same destination, constructs information on the set best and second routes as a forwarding table, and stores the table in the forwarding database 150 (S110). When a packet to be transported from the exterior to a destination is inputted, the receiving section 110 receives the inputted packet so as to queue it to the forwarding section 130.

The forwarding section 130 determines the best and second routes for the packet with reference to the forwarding table stored in the forwarding database 150, referring to a destination address of the packet received from the receiving section 110 (S130). In that regard, the forwarding section 130 queues, to the queue management section 200, information on the best and second routes determined while including the same in the packet.

The queue management section 200 stores, in the queue information storing section 300, status information of the respective queues 420 and 440 along a path corresponding to the determined best and second routes (S150). Preferably, according to the present embodiment, the queue management section 200 stores, in the queue information storing section 300, only status information of the best queue 420 along a path corresponding to the best route. Herein, status information includes information on the number of packets stored in the corresponding queue, minimum/maximum threshold values preset for storing a packet in the corresponding queue, and information (Queue_Full flag) on whether or not the queue is fully occupied with packets.

The queue management section 200 selectively queues the inputted packet to the corresponding queue of the best and second routes based on status information of corresponding queue (the best queue 420 in the present embodiment) stored in the queue information storing section 300 (S200). That is, if the best queue 420 is congested with packets (if more than the maximum threshold value, in the present embodiment), the packets inputted thereafter are queued to the second queue 440. In addition, if the number of packets in the best queue 420 is less than the minimum threshold value, the packets inputted thereafter are queued to the best queue 420.

Thus, the transport section 500 selectively queues and transports the packets, queued to corresponding queues of the best and second routes, to the corresponding output port 620 or 640 according to status information of the respective queues (S400). That is, if the number of packets stored in the best queue 420 is between the maximum threshold value and the minimum threshold value, the transport section 500 extracts the next packet stored in the best queue 420, queues the same, and transports it to the best output port 620. Furthermore, transport section 500 sets the Queue_Full flag of the best queue 420 to ‘0’ if the number of packets stored in the best queue 420 becomes less than the minimum threshold value while extracting the packet stored in the best queue 420, queuing the same, and transporting it via the best output port 620.

Accordingly, the packets inputted are selectively queued to the best queue 420 or the second queue 440 based on whether or not congestion is generated due to packet congestion to the best queue 420, and are transported to the corresponding destination via the best route or second route, thereby reducing packet drop or loss due to congestion of packets inputted.

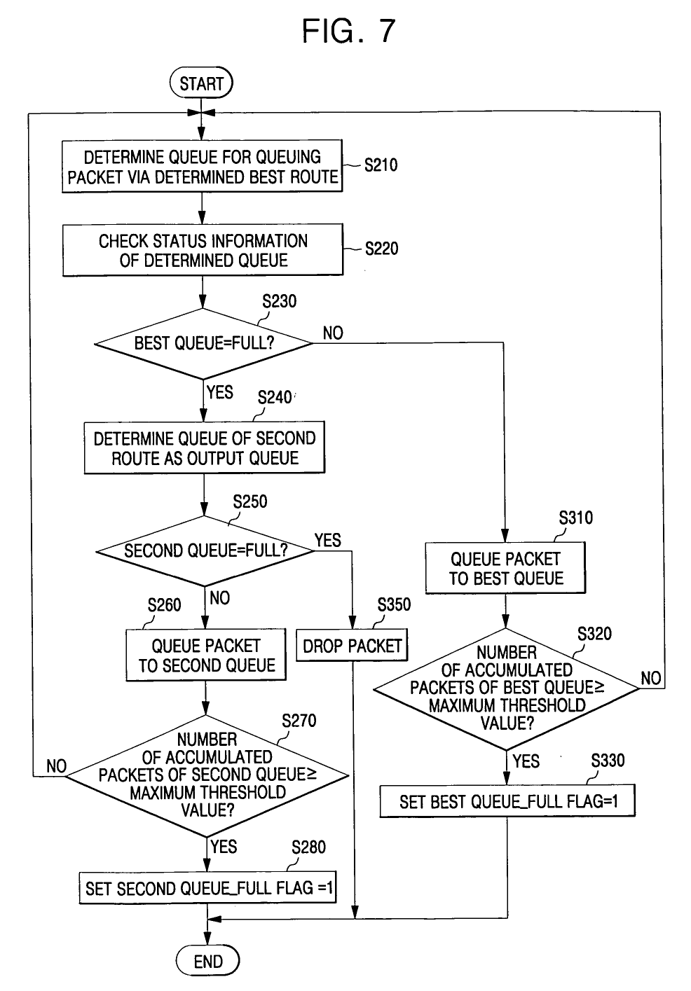

FIG. 7 is a flowchart of step S200 of FIG. 6 in more detail.

First, the queue management section 200 determines the corresponding queue (the best queue 420 in the present embodiment) for queuing a packet via the best route determined by the forwarding section 130 (S210). At this point, the queue management section 200 checks status information of the best queue 420 determined to queue the packet stored in the queue information storing section 300 (S220). As a result of checking status information of the best queue 420, the queue management section 200 determines whether the best queue is congested with packets (Queue_Full Flag=1) (S230).

If the best queue is congested with packets, the queue management section 200 determines the queue 440 of the second route, determined by the forwarding section 130, to be an output queue of the packet (S240). In this regard, the queue management section 200 determines whether the second queue is congested with packets (Queue_Full Flag=1) (S250).

If the second queue is not congested with packets, the queue management section 200 queues the packet to the second queue 440 (S260). During queuing of the packet to the second queue 440, the queue management section 200 determines whether the number of packets accumulated in the second queue 440 is equal to or greater than the preset maximum threshold value (S270).

If the accumulated number of packets of the second queue 440 is equal to or greater than the preset maximum threshold value, the queue management section 200 sets the congestion state (Queue_Full Flag) of the second queue 440 to ‘1’, and queues the packets inputted thereafter to the best queue 420 (S280). In step S270, if the number of accumulated packets is less than the preset maximum threshold value, the queue management section 200 returns to step S210.

Meanwhile, in step S250, if the second queue 440 is fully congested with packets, the queue management section 200 drops the inputted packets (S350).

In step S230, if the second queue 440 is not congested with packets, the queue management section 200 queues the inputted packets to the best queue 420 (S310). During queuing of the inputted packet to the best queue 420, the queue management section 200 determines whether the number of packets accumulated in the best queue 420 is equal to or greater than the preset maximum threshold value (S320).

If the accumulated number of packets of the best queue 420 is equal to or greater than the preset maximum threshold value, the queue management section 200 sets the congestion state (Queue_Full Flag) of the best queue 420 to ‘1’, and queues the packets inputted thereafter to the second queue 440 (S330). If the number of accumulated packets of the best queue 420 is less than the preset maximum threshold value, the queue management section 200 returns to step S210.

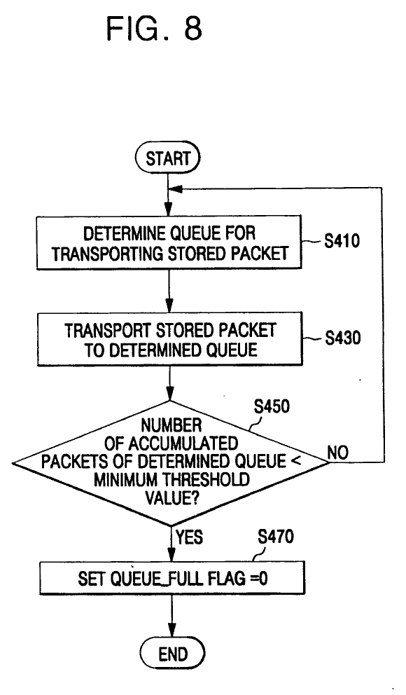

FIG. 8 is a flowchart of step S400 of FIG. 6 in more detail.

First, the transport section 500 determines the queue to which the packets stored in the corresponding queue are to be transported (S410). Preferably, the transport section 500 determines the queue in which the packets to be transported are stored in the queues 420 and 440 in an order inputted formerly thereto. The present embodiment describes the best queue 420 as the queue for packet transporting.

The transport section 500 extracts the stored packet from the determined best queue 420, queues the same, and transports it to the best output port 620 (S430). During queuing and transporting of the packet extracted from the best queue 420, the transport section 500 determines whether the number of packets accumulated in the best queue 420 is less than the preset minimum threshold value (S450).

If the accumulated number of packets of the best queue 420 is less than the preset minimum threshold value, the transport section 500 sets the congestion state (Queue_Full Flag) of the best queue 420 to ‘0’ (S470). If the number of accumulated packets of the best queue 420 is equal to or greater than the preset minimum threshold value, the transport section 500 returns to step S410.

According to the present invention, with the setting of the best and second routes, if the best route is congested with packets in linking thereto, thereby generating congestion, the packets that are inputted thereafter and possibly dropped are queued and transported via the second route, thereby reducing packet loss or drop generated due to congestion of packets inputted.

In addition, based on whether or not there is congestion due to packet congestion in the best queue, the inputted packets are selectively queued to the best queue or the second queue, thus queuing and transporting the same to the corresponding destination via the best route or the second route, and thereby reducing packet loss due to congestion of packets inputted, providing more stable services, and securing high reliability of the network packet transport service.

While the invention has been described in conjunction with various embodiments, the embodiments illustrative only. Accordingly, many alternatives, modifications and variations will be apparent to persons skilled in the art in light of the foregoing detailed description. The foregoing description is intended to embrace all such alternatives and variations falling with the spirit and broad scope of the appended claims.

What is the claimed is:

1. A network routing method for preventing a packet drop, the method comprising the steps of:
(a) presetting best and second routes for a same destination;
(b) determining a route for an inputted packet with reference to the preset best and second routes;
(c) selectively queuing and storing the inputted packet to output queues of the preset best and second routes in accordance with whether there is a congestion in the output queues of the preset best and second routes; and
(d) sequentially queuing the packets stored in the output queues of the preset best and second routes, and transporting the packets stored in the output queues of the preset best and second routes to output ports of corresponding routes, in accordance with an order of input thereof.

2. The method according to claim 1, wherein step (c) comprises the sub-steps of:
selecting the output queue of the preset best route as the output queue for queuing the inputted packets when the determined route is the preset best route;
determining whether the output queue of the preset best route is congested with packets;
when it is determined that the output queue of the preset best route is in a congested state, designating the output queue of the preset second route as the output queue for queuing the inputted packets;
determining whether the output queue of the preset second route is congested with packets; and
when it is determined that the output queue of the preset second route is not in the congested state, queuing the inputted packets to the output queue of the preset second route.

3. The method according to claim 2, further comprising the step of dropping the inputted packets when it is determined that the output queue of the preset second route is determined to be in the congested state.

4. The method according to claim 2, further comprising the steps of:
determining whether a number of packets accumulated in the output queue of the preset second route is more than a preset maximum threshold value during queuing of the inputted packets to the output queue of the preset second route; and
when the number of packets accumulated in the output queue of the preset second route is determined to be more than the preset maximum threshold value, designating the output queue of the preset second route to be in the congested state.

5. The method according to claim 2, further comprising the steps of:
when the output queue of the preset best route is determined to not be in the congested state, queuing the inputted packets to the output queue of the preset best route;
determining whether a number of packets accumulated in the output queue of the preset best route is more than a preset maximum threshold value during queuing the inputted packets to the output queue of the preset best route; and
when the number of packets accumulated in the output queue of the preset best route is determined to be more than the preset maximum threshold value, designating the output queue of the preset best route to be in the congested state.

6. The method according to claim 1, wherein step (d) comprises the sub-steps of:
determining a queue that stores the packets to be extracted based on an order of input in the respective output queues of the preset best and second routes;
extracting the packets stored in the determined queue for queuing and for transport to a corresponding output port;
determining whether the number of packets accumulated in the determined queue is less than a preset minimum threshold value; and
when the number of packets accumulated in the determined queue is determined to be less than the preset minimum threshold value, designating the determined queue to not be in a congested state.

7. An apparatus for network routing, the apparatus comprising:
a forwarding table for storing information on a preset best route and a preset second route for a same destination;
a forwarding section for determining the preset best and second routes for an inputted packet with reference to the forwarding table;
a queue management section for selectively queuing and storing the inputted packet to output queues of the preset best and second routes in accordance with whether there is a congestion in the output queues of the preset best and second routes; and
a transport section for sequentially queuing the packets stored in the output queues of the preset best and second routes, and for transporting the packets stored in the output queues of the preset best and second routes to the output ports of corresponding routes, in accordance with an order of input thereof.

8. The apparatus according to claim 7, further comprising a queue information storing section for storing queue status information including information on whether the output queues of the preset best and second routes are in a congested state, and information on a number of packets stored in an output queue of a present corresponding route, wherein the queue management section selectively queues the inputted packet to the output queues of the preset best and second routes based on the queue status information.

9. The apparatus according to claim 8, wherein the queue management section determines the output queue of the preset second route to be the queue for queuing the inputted packets when the output queue of the preset best route determined by the forwarding section is in the congested state, and wherein the queue management section queues the inputted packets to the output queue of the preset second route when the output queue of the preset second route is not in the congested state.

10. The apparatus according to claim 9, wherein the queue management section drops the inputted packets when the output queues of the preset best and second routes are in the congested state.

11. The apparatus according to claim 9, wherein the queue management section designates the output queue of the preset second route to be in the congested state when a number of packets accumulated in the output queue of the preset second route is more than a preset maximum threshold value during queuing of the inputted packets to the output queue of the preset second route.

12. The apparatus according to claim 9, wherein the queue management section queues the inputted packets to the output queue of the preset best route when the output queue of the preset best route is not in the congested state, and designates the output queue of the preset best route to be in the congested state when a number of packets accumulated in the output queue of the preset best route is more than a preset maximum threshold value during queuing of the inputted packets to the output queue of the preset best route.

13. The apparatus according to claim 7, wherein the transport section extracts the stored packets in an order of input thereof from the output queues of the preset best and second routes, and queues the extracted stored packets, and transports the same to corresponding output ports.

14. The apparatus according to claim 13, wherein the transport section designates the output queue of a route through which the packet is extracted to not be in a congested state when a number of packets accumulated in the output queue of the route through which the packet is extracted is less than a preset minimum threshold value.
